(19) United States
(12) Patent Application Publication
(10) Pub. No.: US 2003/0187736 A1
(43) Pub. Date: Oct. 2, 2003

(54) Patron tracking system

(76) Inventors: David Teague, Oceans Springs, MS (US); Christopher Abraham, Ocean Springs, MS (US); Thomas Bodenstab, Ridgeland, MS (US); Steve Ezell, Brandon, MS (US); Lester McMackin III, Ocean Springs, MS (US); Stanley Salter, Las Vegas, NV (US)

Correspondence Address: Daniel H. Shulman, MAYER, BROWN & PLATT, P.O. Box 2828, Chicago, IL, 60690-2828, US

(21) Appl. No.: 10/114,887

(22) Filed: Apr. 2, 2002

(51) Int. Cl. G06F 17/60

(52) U.S. Cl. 705/14

(57) ABSTRACT

A patron tracking system for tracking patron activity in a casino enterprise, wherein the casino enterprise comprises a home casino and one or more non-home casinos, the patron tracking system comprising: a home local casino management system at the home casino; one or more non-home casino management systems at the one or more non-home casinos; wherein the local casino management systems contain customer data related to patron activity; a message router for transmitting customer data between the home and non-home local casino management systems; and wherein certain customer data residing on the home local casino management system is not shared with the one or more non-home local casino management systems.

### BACKGROUND OF THE INVENTION

1. Field of the Invention

The present invention relates to a system and method for tracking patron activity at a casino. Particularly, the present invention is directed to a system and method for tracking patron activity at a casino enterprise wherein certain patron customer data is maintained at a home casino and transmitted to other non-home casinos within the casino enterprise.

2. Description of Related Art

A variety of methods and systems are known for tracking patron activity at casinos. Such activity usually includes, without limitation, one or more of wagering activity, other entertainment activity (such as purchase of tickets to shows and other casino-offered presentations), lodging activity, meals activity, or other activities that a casino enterprise may find desirable to monitor concerning its patrons. In the typical casino environment, a casino comprises a casino enterprise comprised of several affiliated casino properties. For example, a casino enterprise may have venues in Las Vegas, Atlantic City and myriad other land-based and/or water-based casinos. In addition, it is desirable to track the activity of patrons of the casino enterprise to provide rewards such as complimentary items (“comps”) based upon the level of activity of the patron. For example, a patron who has a high level of wagering activity might receive a comp in the form of a free meal or lodging to enhance the loyalty of the patron to the particular casino venue or casino enterprise.

Typically, the patron activity is stored in a casino management system at the local venue where the patron activity occurs. However, because a casino venue may be one of several affiliated casino venues, it is desirable to make customer data related to the patron activity available to other affiliated venues so that a patron may have the benefit of rewards earned at other casino venues throughout the casino enterprise. This need is especially acute when the patron travels to locations wherein several casino enterprises are represented, such as Las Vegas. There is also a need for a system that permits patron accounts to be accessed at more than one casino venue simultaneously such as, for example, when a husband and wife simultaneously play at affiliated venues on a single account.

One solution to the problem has been to create a centralized patron database, containing all of the patron activity information, linked to local casino management systems. That solution, described in U.S. Pat. No. 5,761,647 to Boushy, however, suffers from several inefficiencies and disadvantages. The requirement for a centralized patron database which contains all patron information poses risks for the entire system if, for example, the database fails or the connection between the database and local casinos is adversely affected (such as by heavy traffic). In addition, the system disclosed in the '647 patent is not easily scalable or transferable. Data storage limitations also make a centralized database less than desirable. In addition, it may be desirable to make certain additional benefits available to the patron at his home casino, i.e., the casino where the patron enrolls or regularly participates in casino activity. Because the '647 patent utilizes a completely shared centralized database, no distinction is made between a patron's home casino and other casinos in the casino enterprise. This is yet another disadvantage of the system of the '647 patent.

There thus remains a need for an efficient and economic method and system for linking affiliated casino venues within a casino enterprise for tracking and rewarding patron activity.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

One embodiment of the present invention includes a patron tracking system for tracking patron activity in a casino enterprise, wherein the casino enterprise comprises a home casino and one or more non-home casinos, the patron tracking system comprising: a home local casino management system at the home casino; one or more non-home casino management systems at the one or more non-home casinos; wherein the local casino management systems contain customer data related to patron activity; a message router for transmitting customer data between the home and non-home local casino management systems; and wherein certain customer data residing on the home local casino management system is not shared with the one or more non-home local casino management systems. In another embodiment, the patron tracking system further comprises an enterprise server connected to the local casino management systems. In yet further embodiments, the message router transmits customer data from the home local casino management system to one or more non-home local casino management systems through the enterprise server. In yet another embodiment, a summary of the customer data residing on the home local casino management system resides on the enterprise server. In a further embodiment, the summary of customer data is shared between the enterprise server and the one or more non-home local casino management systems.

Another embodiment of the present invention includes a method for tracking patron activity for a patron of a casino enterprise comprised of a home casino and one or more non-home casinos, the method comprising: maintaining customer data relating to the patron activity at a home local casino management system at the home casino, the customer data comprising at least a point balance; transmitting the point balance to a non-home local casino management system when the patron commences patron activity at the non-home casino to create a non-home temporary point balance; debiting or crediting the non-home temporary point balance as a result of patron activity at the non-home casino; transmitting the non-home temporary point balance to the home local casino management system when the patron completes patron activity at the non-home casino; and recalculating the patron's point balance in the home local casino management system based upon the non-home temporary point balance. In yet another embodiment, the method further comprises: providing a summary of the customer data from the home local casino management system to an enterprise server, the summary comprising at least the patron's point balance; and requesting the summary of the customer data from the enterprise server at the non-home casino when the patron commences patron activity at the non-home casino.

Another embodiment of the invention includes a method for tracking loyalty rewards related to a patron based upon patron activity for a patron of a casino enterprise, the casino enterprise comprising a home casino having a home local casino management system and one or more non-home casinos, each having a non-home local casino management system, the method comprising: storing an offer of a loyalty reward at the home casino local casino management system; making the offer available at the non-home local casino management system at the non-home casino in which the patron commences patron activity; if the patron redeems the offer at the non-home casino, sending redemption information to the home local casino management system wherein the offer is removed from the home local casino management system; and if the patron does not redeem the offer at the non-home casino, removing the offer from the non-home local casino management system. In other embodiments, the method further comprises storing the offer of a loyalty reward at an enterprise server. In yet further embodiments, the step for making the offer available at the non-home local casino management system comprises requesting and receiving outstanding offers from the enterprise server. In other embodiments, the method further comprises if the patron redeems the offer at the non-home casino, sending redemption information to the enterprise server wherein the offer is removed from the enterprise server.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic representation of an embodiment of the patron tracking system.

FIG. 2 is a schematic representation of a local casino management system according to an embodiment of the present invention.

FIG. 3 is a representation of a method for tracking patron activity according to an embodiment of the present invention.

FIG. 4 is a representation of a method for tracking patron activity according to another embodiment of the present invention.

FIG. 5 is a representation of a method for tracking patron activity according to another embodiment of the present invention.

FIG. 6 is a representation of a method for tracking patron activity according to another embodiment of the present invention.

### DETAILED DESCRIPTION OF THE PREFERRED EMBODIMENT

Reference will now be made to the present preferred embodiments of the invention, examples of which are illustrated in the accompanying drawings. The method and corresponding steps of the invention will be described in conjunction with the detailed description of the system.

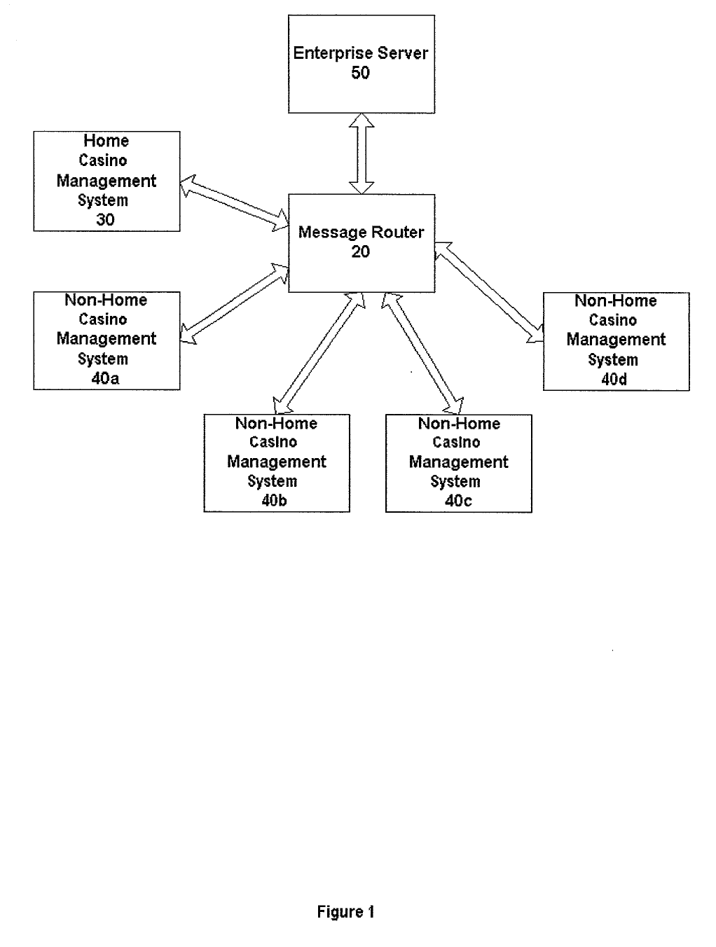

The methods and systems presented herein may be used for tracking casino patron activity across a casino enterprise. The present invention is particularly suited to make certain benefits available to casino patrons at locations throughout the casino enterprise. For purpose of explanation and illustration, and not limitation, an exemplary embodiment of the system in accordance with the invention is shown in FIG. 1 and is designated generally by reference character 10.

As shown in FIG. 1, the system 10 generally comprises a message router 20, a home local casino management system 30, one or more non-home local casino management systems 40a, b, c, d (non-home local casino management system, generally designated as 40), and preferably an enterprise server 50. Each of the respective elements will be described below in more detail. It will be appreciated from the descriptions below that variations and modifications may be made to the exemplary embodiment set forth in FIG. 1 without departing from the scope of the claims of the invention. For example, although FIG. 1 depicts an embodiment comprising four non-home local casino management systems, the present invention includes embodiments having any number of one or more non-home local casino management systems 40. A small casino enterprise that comprises only two locations may have, in addition to the home local casino management system 30, just one non-home local casino management system 40. Larger casino enterprises with many affiliated casino venues may have, in addition to the home local casino management system 30, dozens of non-home local casino management systems 40. In addition, it will be appreciated that, depending upon the information required by the non-home local casino management system 40, an enterprise server 50, though preferred, may not be necessary.

The casino enterprise includes one home casino and one or more non-home casinos. Any of the casinos in the casino enterprise may be a home casino, depending upon the patron. Typically, a patron's home casino will be the casino venue where the patron most often engages in casino activity. Alternatively, or as a default, the home casino may be the casino venue where the patron initially enrolls in a casino loyalty program administered through the present invention. All other casino venues in the casino enterprise will therefore be deemed non-home casinos. A patron may change a non-home casino to his home casino at any time, but cannot have more than one home casino. Alternatively, or in addition, the system according to an embodiment of the present invention may periodically review casino activity and re-assign a patron's home casino if, for example, a patron engages in casino activity over a length of time primarily at a non-home casino.

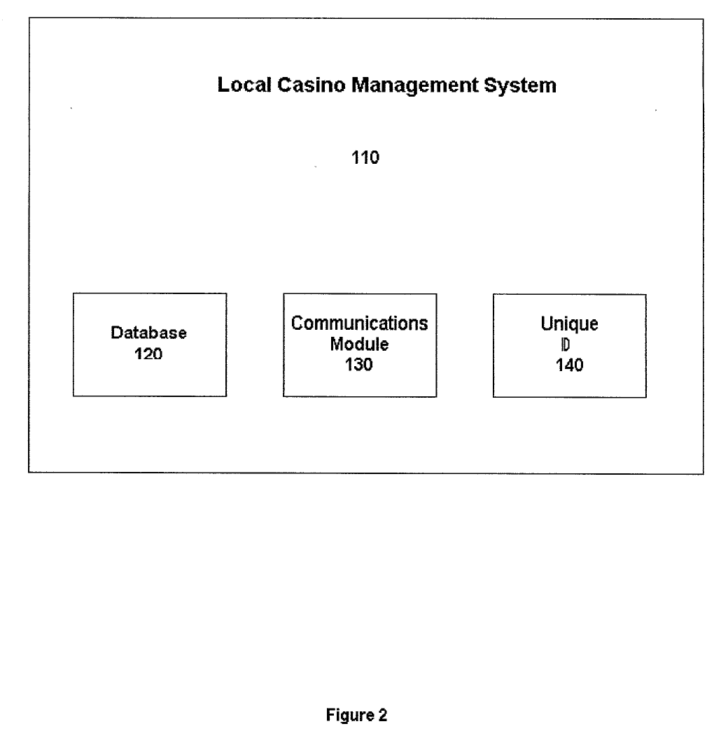

The local casino management system will now be described in conjunction with FIG. 2. Each casino venue has its own local casino management system 110. The local casino management system at a patron's home casino is the home local casino management system 30, whereas local casino management systems at a patron's non-home casinos are the non-home local casino management systems 40. A casino venue may be any venue owned, operated or otherwise affiliated with a casino enterprise, whether or not gaming activity is available. For example, a casino enterprise may include several gaming venues (such as, for example, riverboats or traditional casinos, or Internet web site-based casinos), but may also separately include theatres, restaurants or hotels, for example, where no gaming activity takes place. Additionally, a casino venue may be anywhere that a casino enterprise makes its casino services available such as, for example, airports having slot machines owned or operated by the casino enterprise, or an Internet web site. Each of those venues may be regarded as a casino venue for purposes of the invention and preferably, although not necessarily, has a local casino management system to most efficiently utilize the system and method of the present invention.

The local casino management system 110 is a computer-based system for storing and facilitating the sharing of casino patron information. The local casino management system 110 is usually embodied in some computer software and hardware at each casino venue that includes each of the elements of the system 110. Specifically, the local casino management system 110 comprises at least a database 120 of casino patron information, a communications module 130, and a unique venue ID 140. The database 120 contains information concerning the casino activity and identity of the patron. The amount and type of information stored in the database for the patron depends upon whether the local casino management system is a home or non-home local casino management system. In one embodiment, the database 120 for non-home local casino management systems will contain summaries of the data in the database of the home local casino management system for each patron. That is, for each patron, the database in the home local casino management system 30 at the home casino will contain information not contained in the database 120 in the non-home local casino management systems 40 at the patron's non-home casinos.

The local casino management system 110 of the present embodiment also comprises a communications module 130 to establish communications with the message router 20. The communications module 130 may comprise an internet, intranet, Ethernet or other telecommunications connection and related software for sending and receiving information over a network.

In addition, the local casino management system 110 of the present embodiment also comprises a unique venue ID 140. The unique venue ID 140 is used to determine whether, for a particular patron, the local casino management system 110 is the home or one of the non-home local casino management systems. In the preferred embodiment, each patron will have a unique patron ID that comprises, in part, the unique venue ID 140 for the patron's home casino. In this manner, when a local casino management system 110 receives a request for information about a patron (for example, through an interface with a patron casino card, described below), the local casino management system 110 will compare the patron ID to the unique venue ID for that local casino management system 110. If the local casino management system 110 is the patron's home local casino management system 30, the information from the database 120 is immediately available and will be updated based upon the patron's casino activity.

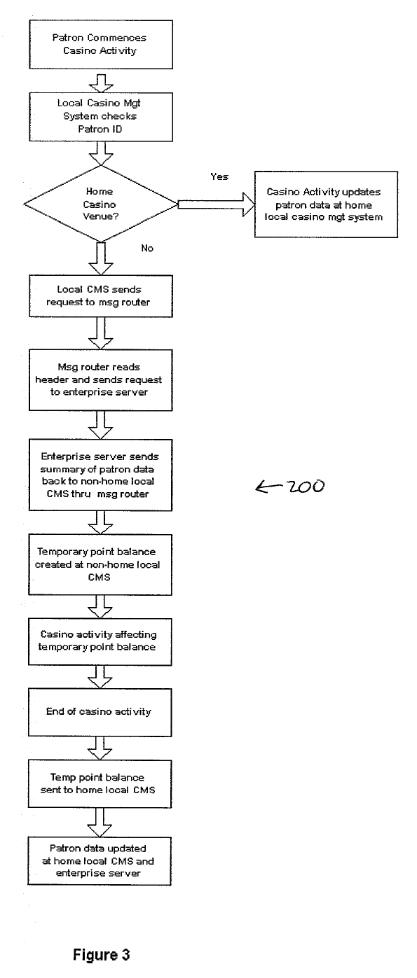

FIG. 3 depicts a process 200 that may take place according a preferred embodiment if the relevant portion of the patron ID does not match the unique venue ID 140 (in other words, if the patron commences casino activity at a non-home casino). The non-home local casino management system 40 sends a query, via the message router 20, to the enterprise server 50. The enterprise server 50 identifies, based upon the patron ID, the patron's home casino and sends to the non-home casino management system 40 patron-specific data and patron-property data. An example, by way of illustration only and not by way of limitation, of the patron-specific data is set forth below in Table 1. An example, by way of illustration only and not by way of limitation, 20 of the patron-property data is set forth below in Table 2. The enterprise server 50 also determines, based upon a review of the patron-property data, whether the patron has any points available at another casino venue. If so, the enterprise server 50 identifies the venues wherein points are available, and the non-home local casino management system 40 requests a transfer of those point balances from the applicable local casino management system where such points are available. In the preferred embodiment, unless the patron is currently accumulating points at another casino venue (for example, the patron's spouse is currently engaging in casino activity on the patron's account), all of the points are kept at the patron's home local casino management system 30. In this manner, traffic is reduced and use of the enterprise server is eliminated most of the time because, preferably, the points will reside at the location most often used by the patron. The enterprise server 50 will also transmit to the non-home local casino management system 40 a record of outstanding loyalty reward offers related to the patron and any other special interest items related to the patron (for example, the drinks or types of food the patron most likes).

When the patron has completed his casino activity, the patron-property data is updated and transmitted from the non-home local casino management system 40 back to the enterprise server 50. The enterprise server 50 compares the patron-property data to the patron-specific data and, where certain data has been modified as a result of the casino activity, updates the patron-specific data and sends the new patron-specific data to the home local casino management system 30. Also when the casino activity is terminated at the non-home local casino, the special interest items are deleted from the non-home local casino management system 40. In this manner, efficiency in data storage but also some level of redundancy is built into the system and safeguards are established so that, according to the preferred embodiment, in the event the enterprise server 50 is inoperable, the patron-specific data (including up-to-date point balance) is always available at the venue in which the patron is most likely to engage in casino activity.

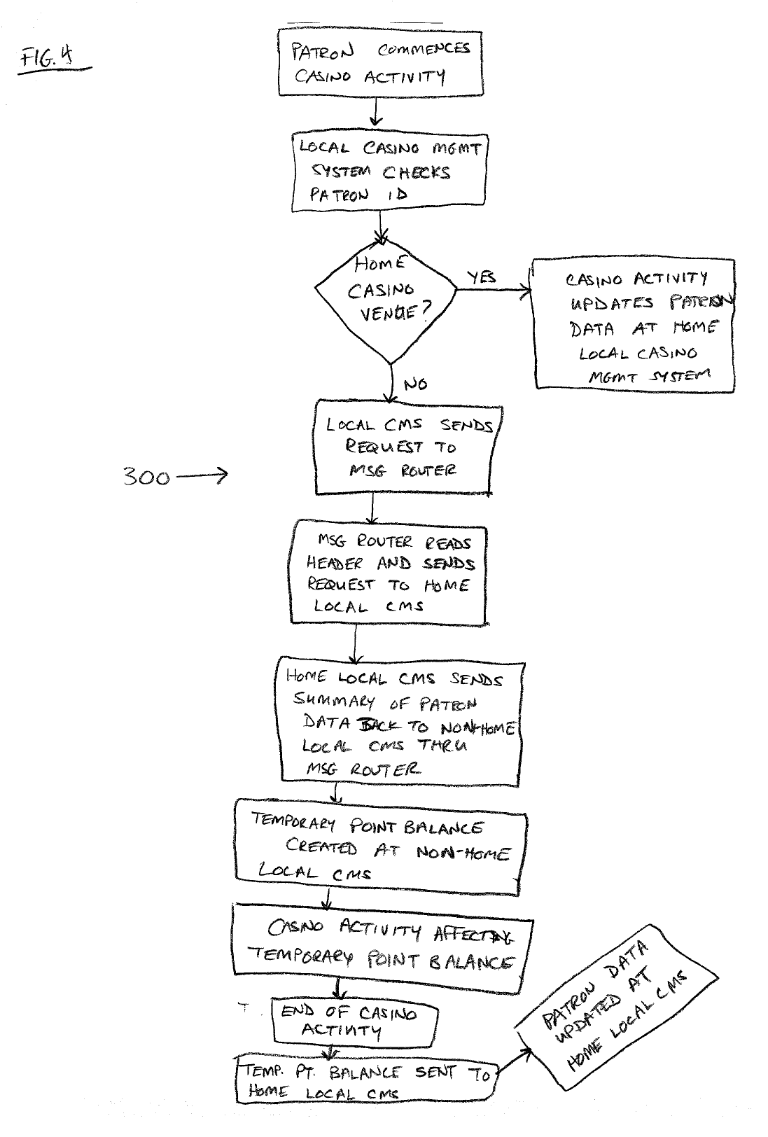

FIG. 4 depicts a process 300 that may take place according to an alternative embodiment if the relevant portion of the patron ID does not match the unique venue ID 140 (in other words, if the patron commences casino activity at a non-home casino). In this instance, the system is provided without an enterprise server 50, or it is not desired to utilize the enterprise server 50 for the particular transaction. According to this embodiment of the method 300, the local casino management system 110 will send a request, via the communications module 130, to the message router 20 for information (such as point balance) for the patron from the patron's home local casino management system 30. In this embodiment, each local casino management system 110 includes a look-up table having the unique venue ID for each other venue. Accordingly, the non-home local casino management system 40 can determine, based upon the unique venue ID 140 in the patron's ID, whether and where to send a request for patron data. In this embodiment, the message router 20 will route a request to the home local casino management system 30, which will send patron-specific and patron-property data (including, for example, the point balance) through the message router 20 back to the local casino management system 110. A temporary point balance is created at the local casino management system 110 that the patron may add to or draw from as he engages in his casino activity. When the patron completes the casino activity at the non-home casino, the local casino management system 110 sends the end temporary point balance (based upon any credits or debits thereto resulting from the patron's casino activity) via the communications module 130 to the message router 20 which routes the information to the patron's home local casino management system 30. The patron's new point balance is then recalculated at his home local casino management system 30 and maintained there in the database. In this manner, efficient sharing of information with minimal traffic over the network and minimal storage requirements is achieved.

The present embodiment of the invention also comprises a message router 20. The message router 20 comprises a computer-based system that reads the data sent to or from one of the local casino management systems 110, determines based upon the data to or from whom to request and send data about a patron, and transmits the data.

According to one embodiment, the patron-specific data kept in the database of the home local casino management system 30 and, if an enterprise server 50 is utilized, at the enterprise server 50, is organized according to predetermined data fields. An example of a collection of data fields suitable to the preferred embodiment is set forth below in Table 1. It should be appreciated that the particular field names, field size, digits and decimals are merely matters of programmer convenience. In addition, it will be appreciated that additional or fewer data fields may be utilized depending upon the needs of the casino enterprise. The patron-specific data is sent to the non-home local casino management system 40 upon the commencement of casino activity there.

TABLE 1
Example of Patron-Specific Data

| Field | Field | | | |
|---|---|---|---|---|
| Name | Size | Digits | Decimals | Description |
| SYIDCM | 5 | 9 | 0 | Customer system Id number |
| SYI2CM | 5 | 9 | 0 | Customer system Id number 2 |
| SPSYCM | 1 | 0 | 0 | Spouse account (Y = Yes or Blank) |
| PR@YCM | 1 | 0 | 0 | Payroll account (Y = Yes or Blank) |
| NAMECM | 30 | 0 | 0 | Customer name |
| TTL@CM | 3 | 0 | 0 | Customer title (i.e. MR. MRS, DR) |
| LNM@CM | 15 | 0 | 0 | Customer last name |
| FNM@CM | 15 | 0 | 0 | Customer first name |
| MI@@CM | 1 | 0 | 0 | Customer middle initial |
| SFX@CM | 3 | 0 | 0 | Customer suffix (i.e. JR. SR, III) |
| SS#@CM | 5 | 9 | 0 | Social security number |
| DOB@CM | 4 | 6 | 0 | Date of birth |
| EMPLCM | 30 | 0 | 0 | Employer name |
| POS@CM | 30 | 0 | 0 | Employment position |
| ADI@CM | 30 | 0 | 0 | Address 1 |
| AD2@CM | 30 | 0 | 0 | Address 2 |
| CTY@CM | 16 | 0 | 0 | City |
| ST@@CM | 2 | 0 | 0 | State |
| ZIP@CM | 10 | 0 | 0 | Zip Code |
| CTR@CM | 16 | 0 | 0 | Country |
| FORACM | 1 | 0 | 0 | Foreign Address (Y = Yes) |
| LCLYCM | 1 | 0 | 0 | Local customer (Y = Yes or Blank) |
| MAILCM | 1 | 0 | 0 | Mail code (R = Res, B = Bus, O = Other, N = None) |
| BAD@CM | 1 | 0 | 0 | Bad address flag (Y = Yes or Blank) |
| DNI@CM | 1 | 0 | 0 | Do not invite (Y = Yes or Blank) |
| EMALCM | 30 | 0 | 0 | E-Mail Address |
| AC@@CM | 2 | 3 | 0 | Area code |
| PH#@CM | 4 | 7 | 0 | Phone number |
| AC@ECM | 2 | 3 | 0 | Employer area code |
| PH#ECM | 4 | 7 | 0 | Employer phone number |
| AC@OCM | 2 | 3 | 0 | Other area code |
| PH#OCM | 4 | 7 | 0 | Other phone number |
| CCIDCM | 6 | 11 | 0 | Central credit Id number |
| NNAMCM | 15 | 0 | 0 | Nickname |
| SEX@CM | 1 | 0 | 0 | Customer's sex (M = Male, F = Female) |
| SNAMCM | 15 | 0 | 0 | Spouse's name |
| DOBSCM | 4 | 6 | 0 | Spouse's date of birth |
| ANIVCM | 3 | 4 | 0 | Anniversary month/day |
| SRC@CM | 10 | 0 | 0 | Source code |
| PCHMCM | 2 | 0 | 0 | Home Property |
| CRD#CM | 11 | 0 | 0 | Customer player card number |
| CRDSCM | 2 | 3 | 0 | Number of cards issued |
| CLSQCM | 1 | 1 | 0 | Card Sequence |
| CDPSCM | 1 | 0 | 0 | Card print status (M = Mail, P = Prntd, N = None or Blnk |
| CDIHCM | 3 | 5 | 0 | Card issue 100YR date |
| SPTYCM | 1 | 0 | 0 | Share points & comps eamed (Y = Yes or Blank) |
| PIN@CM | 16 | 0 | 0 | PIN encrypted |
| CPLYCM | 1 | 0 | 0 | Cashless player (Y = Yes or Blnk) |
| CAAYCM | 1 | 0 | 0 | Cashless amount allowed (Y = Yes or Blnk) |
| PRQYCM | 1 | 0 | 0 | PIN required for cashless (Y = Yes or Blnk) |
| HDAECM | 3 | 5 | 0 | Account established 100YR date |
| HDLCCM | 3 | 5 | 0 | Last change 100YR date |
| TIMCCM | 3 | 4 | 0 | Time of last change in HH:MM format |
| PCUCCM | 2 | 0 | 0 | User Property |
| UINCCM | 10 | 0 | 0 | Changed by user initials |
| PL@PCM | 1 | 0 | 0 | Pit games player (Y = Yes or Blank) |
| PL@SCM | 1 | 0 | 0 | Slot player (Y = Yes or Blank) |
| INHSCM | 1 | 0 | 0 | In-house (Y = Yes or blank) |
| IH@PCM | 1 | 0 | 0 | In-house pit customer (Y = Yes or blank) |
| IH@SCM | 1 | 0 | 0 | In-house slot customer (Y = Yes or blank) |
| IH@OCM | 1 | 0 | 0 | In-house other customer (Y = Yes or blank) |
| SNDSCM | 1 | 0 | 0 | Send info to slot system (Y = Yes or Blank) |
| SNDMCM | 1 | 0 | 0 | Send info to MP system (Y = Yes or Blank) |
| L#@@CM | 1 | 1 | 0 | Record maintenance level nbr |
| DELCCM | 1 | 0 | 0 | Record Level (′= Normal, M = Master, X = Delete) |

Each venue in which a patron has engaged in casino activity also has in its local casino management system 110 and, if an enterprise server 50 is utilized, at the enterprise server 50, patron-property data. An example of a collection of data fields suitable to the preferred embodiment of the patron-property data is set forth below in Table 2. It should be appreciated that the particular field names, field size, digits and decimals are merely matters of programmer convenience. In addition, it will be appreciated that additional or fewer data fields may be utilized depending upon the needs of the casino enterprise. The patron-property data is sent to the non-home local casino management system 40 upon the commencement of casino activity there.

TABLE 2
Example of a Patron-Property Data.

| Field | Field | | | |
|---|---|---|---|---|
| Name | Size | Digits | Decimals | Description |
| PC@@CP | 2 | 0 | 0 | Local Property |
| SYIDCP | 5 | 9 | 0 | Customer system Id number |
| ATYPCP | 1 | 0 | 0 | Account type (C = Credit, L = Limited, M = Mkting) |
| DSPCCP | 1 | 0 | 0 | Marker disposition code |
| STSCCP | 1 | 0 | 0 | Account credit status |
| LM$CCP | 4 | 7 | 0 | Current limit |
| HDCLCP | 3 | 5 | 0 | Current limit 100YR date |
| APCLCP | 10 | 0 | 0 | Current limit approver |
| LM$TCP | 4 | 7 | 0 | Temporary limit |
| HDTLCP | 3 | 5 | 0 | Temporary limit 100YR date |
| APTLCP | 10 | 0 | 0 | Temporary limit approver |
| STSPCP | 1 | 0 | 0 | Previous account status |
| LM$PCP | 4 | 7 | 0 | Previous limit |
| HDPLCP | 3 | 5 | 0 | Previous limit 100YR date |
| APPLCP | 10 | 0 | 0 | Previous limit approver |
| HDLTCP | 3 | 5 | 0 | Last transaction 100YR date |
| HDCSCP | 3 | 5 | 0 | Cash transaction 100YR date |
| CS$ICP | 5 | 9 | 2 | Cash in total |
| CS$OCP | 5 | 9 | 2 | Cash out total |
| FM$@CP | 5 | 9 | 2 | Current front money balance |
| FM$CCP | 5 | 9 | 2 | Front money credit for total used |
| MK$CCP | 5 | 9 | 2 | Current marker balance - Cage |
| MK$PCP | 5 | 9 | 2 | Current marker balance - Pit |
| CK$@CP | 5 | 9 | 2 | Current checks balance |
| RT$@CP | 5 | 9 | 2 | Current returns balance |
| RD$@CP | 5 | 9 | 2 | Current redeposit balance |
| SK$@CP | 5 | 9 | 2 | Current safekeeping balance |
| WO$@CP | 5 | 9 | 2 | Current write off balance |
| BPETCP | 5 | 9 | 0 | Bonus points earned total |
| BPCTCP | 5 | 9 | 0 | Bonus points card award total |
| BPPTCP | 5 | 9 | 0 | Bonus points promotions total |
| BPCRCP | 5 | 9 | 0 | Bonus points credit adjustments |
| BPDBCP | 5 | 9 | 0 | Bonus points debit adjustments |
| BPRTCP | 5 | 9 | 0 | Bonus points redeemed total |
| BPCBCP | 5 | 9 | 0 | Bonus points current balance |
| C$ETCP | 6 | 11 | 2 | Comp dollars earned total |
| C$CTCP | 6 | 11 | 2 | Comp dollars card award total |
| C$PTCP | 6 | 11 | 2 | Comp dollars promotions total |
| C$CRCP | 6 | 11 | 2 | Comp dollars credit adjustments |
| C$DBCP | 6 | 11 | 2 | Comp dollars debit adjustments |
| C$RTCP | 6 | 11 | 2 | Comp dollars redeemed total |
| C$CBCP | 6 | 11 | 2 | Comp dollars current balance |
| SNDSCP | 1 | 0 | 0 | Send info to slot system (Y = Yes or Blank) |
| SNDMCP | 1 | 0 | 0 | Send info to MP system (Y = Yes or Blank) |
| L#@@CP | 1 | 1 | 0 | Record maintenance level nbr |
| DELCCP | 1 | 0 | 0 | Record Level (′ = Normal, M = Master, X = Delete) |

In some embodiments utilizing the enterprise server 50, requests for patron data from a non-home local casino management system 40 may be routed via the message router to the enterprise server 50. Because the enterprise server 50 contains a minimum amount of 5 information expected to be needed by the non-home local casino management system 40, further communication between the home local casino management system may not be necessary. After the patron has completed casino activity at the non-home casino venue, updated patron data (including, for example, point balance) may be sent to the enterprise server 50. The enterprise server 50 may hold all patron data for all casino patrons to submit to their respective home local casino management systems 30 at a specific time. In this manner, connections among the various systems can be more efficiently scheduled and managed. The home local casino management system 30 will also periodically update the summary of patron information contained at the enterprise server 50. In addition, or alternatively, when the enterprise server 50 receives a request for a summary from a non-home local casino management system 40 via the message router 20, the enterprise server 50 may send a query to the home local casino management system 30 to check whether there have been any updates to the patron's data since the last upload of a summary to the enterprise server 50. If there has not been any intervening activity, the enterprise server 50 will simply transmit the summary maintained therein, via the message router 20, to the non-home local casino management system 40. If there have been updates, the enterprise server 50 will send a request to the home local casino management system 30 for a new summary. The home local casino management system 30 will transmit a new summary to the enterprise server 50 for distribution to non-home local casino management systems 40. In alternative embodiments, the enterprise server 50 may be assumed to have the most current data and may not query the home local casino management system 30.

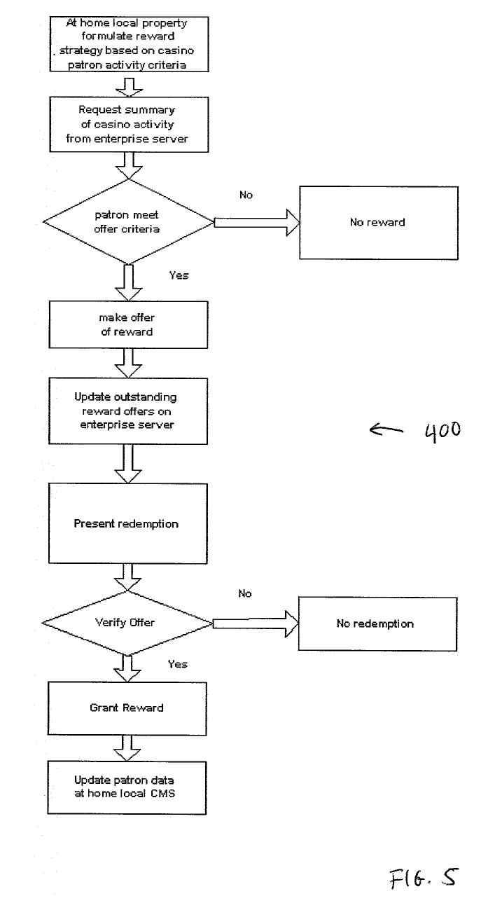

FIG. 5 depicts a transaction according to an embodiment of the present invention utilizing the enterprise server 50. The depicted transaction is according to the preferred most efficient use of the embodiment of the system including the enterprise server 50. In this transaction, one or more rewards are offered to the patron at a non-home casino based upon the patron's history of casino activity. In situations wherein the non-home casino offers rewards based only upon a single factor, such as point balance, other transactions involving the home and non-home casinos, such as those depicted in FIG. 3, may be more appropriate.

In FIG. 5, a non-home casino desires to offer rewards to casino patrons or a particular casino patron based upon certain past casino activity. To verify eligibility, it is necessary to quickly view past casino activity. This data may be available by determining how many casino venues have patron-property data concerning the patron. Alternatively, or in addition, the patron-specific data may reflect in how many venues (and which venues) the patron has engaged in casino activity. When it is determined which venues have patron-property data, the patron-property data can be transmitted to the non-home local casino management system 40 for review at the non-home casino. According to the embodiment, therefore, the non-home local casino management system 40 sends a request, via the message router 20, to the enterprise server 50 for the patron's data (the patron-specific and patron-property data). If the patron's casino activity does not meet the criteria for the offer of the rewards, the non-home casino does not grant the rewards. If the patron does meet the criteria, the rewards are offered to the patron. The non-home local casino management system 40 sends an update to the enterprise server 50 where a record of outstanding offers (such as, for example and without limitation, a free meal) which have not been redeemed is kept.

When the patron desires to redeem the offer, either at a non-home casino (including the offering non-home casino) or at the home casino, the enterprise server 50 is queried to verify that an offer is outstanding. If no offer is outstanding, there is no redemption. If the offer is outstanding, the patron is provided with the reward (for example, a meal or additional points in his balance), and the patron's data is updated accordingly at the home local casino management system 30. In this manner, the home local casino management system 30 is not involved in the transaction until the reward offer is redeemed. In addition, rewards can be tailored to a specific casino venue. In that case, the reward offer is maintained in the patron-property data at the local casino management system 110.

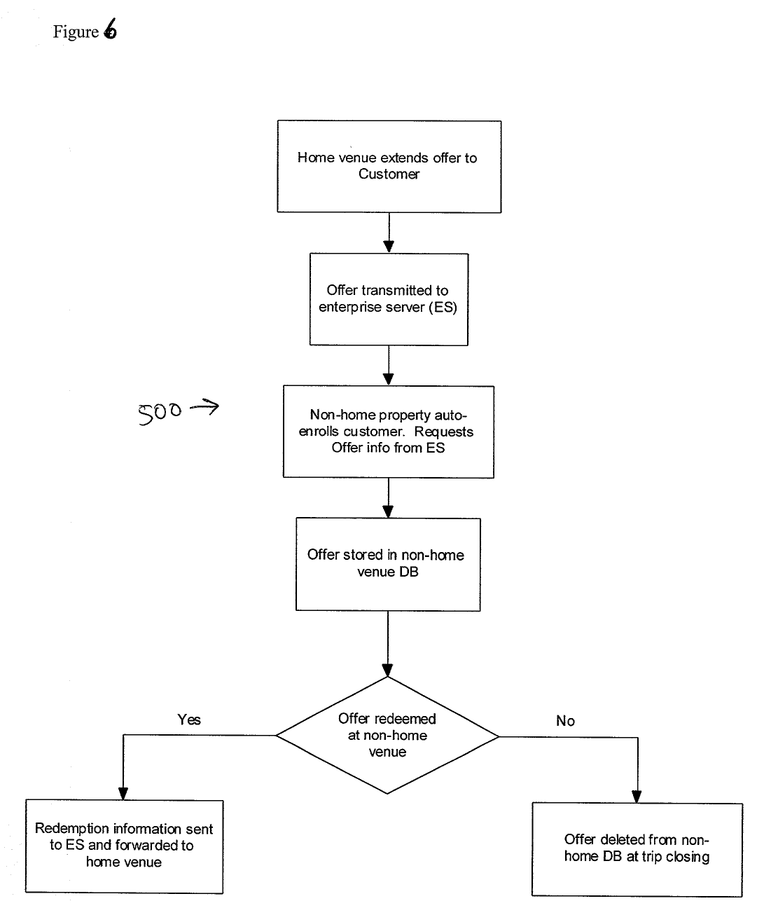

In alternative embodiments, it may be desirable to coordinate all offers of loyalty rewards through the home casino. The method 500 according to this embodiment is depicted in FIG. 6. It is determined, based upon patron data at the home local casino management system 30, whether and which loyalty reward to offer. Once it is determined that an offer will be made, the offer is transmitted to the enterprise server 50. The offer may also be kept at the home local casino management system 30. When a patron commences casino activity at the home casino, his award is immediately made available for redemption and, upon redemption, the offer is deleted or recorded as “redeemed” at the enterprise server 50. When, on the other hand, a patron commences casino activity at a non-home casino, the non-home local casino management system 40 receives from the enterprise server 50, as part of the patron data transmitted to the non-home local casino management system 40, information related to all outstanding offers. The non-home local casino management system 40 then makes the offer available at the non-home casino by, for example, including the offer in the patron's patron-property data. If the offer is not redeemed for use at the non-home casino, the offer information is deleted from the patron-property data at the non-home local casino management system 40 when the patron completes his casino activity. If the patron desires to redeem the offer, however, and the offer is redeemable at the non-home casino, the offer may be redeemed and the patron receives whatever reward the offer conferred. When the patron completes his casino activity, the non-home local casino management system 40 transmits its patron-property data back to the enterprise server 50, which determines that the outstanding offer has been redeemed. The enterprise server 50 then forwards the updated patron data to the home local casino management system 30 so that the offer is no longer available anywhere within the casino enterprise. In this manner, where offers are tailored to specific patron data that may not be shared among local casino management systems 110, offers can still be made available across the casino enterprise.

Embodiments of the present invention can be administered in a number of ways. Typically, the casino patron will have a magnetic or other machine-readable medium, such as a key card or similar device, that will contain the unique patron ID number. In the preferred embodiment, although not necessarily, the first two digits of the patron ID number represent the patron's home casino. However, it should be appreciated that other acceptable methods are available for storing the patron's home casino either as part of, or in conjunction with, the patron's unique patron ID. When the patron begins to engage in any casino activity, he may enter his card into a reading device connected to the local casino management system which will retrieve the data from the card and make his point balance (or other casino loyalty features) immediately available if it is the patron's home casino venue, or retrieve and create a temporary point balance (as described above) if it is a non-home casino venue. The card may be used for a variety of other purposes to enhance the patron's casino experience, including use as his room key.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. A patron tracking system for tracking patron activity in a casino enterprise, wherein the casino enterprise comprises a home casino and one or more non-home casinos, the patron tracking system comprising:
a home local casino management system at the home casino;
one or more non-home casino management systems at the one or more non-home casinos;
wherein the local casino management systems contain customer data related to patron activity;
a message router for transmitting customer data between the home and non-home local casino management systems; and
wherein certain customer data residing on the home local casino management system is not shared with the one or more non-home local casino management systems.

2. The patron tracking system of claim 1 further comprising an enterprise server connected to the local casino management systems.

3. The patron tracking system of claim 2 wherein the message router transmits customer data from the home local casino management system to one or more non-home local casino management systems through the enterprise server.

4. The patron tracking system of claim 3 wherein a summary of the customer data residing on the home local casino management system resides on the enterprise server.

5. The patron tracking system of claim 4 wherein the summary of customer data is shared between the enterprise server and the one or more non-home local casino management systems.

6. A method for tracking patron activity for a patron of a casino enterprise comprised of a home casino and one or more non-home casinos, the method comprising:
maintaining customer data relating to the patron activity at a home local casino management system at the home casino, the customer data comprising at least a point balance;
transmitting the point balance to a non-home local casino management system when the patron commences patron activity at the non-home casino to create a non-home temporary point balance;
debiting or crediting the non-home temporary point balance as a result of patron activity at the non-home casino;
transmitting the non-home temporary point balance to the home local casino management system when the patron completes patron activity at the non-home casino; and
recalculating the patron's point balance in the home local casino management system based upon the non-home temporary point balance.

7. The method of claim 6 further comprising:
providing a summary of the customer data from the home local casino management system to an enterprise server, the summary comprising at least the patron's point balance; and
requesting the summary of the customer data from the enterprise server at the non-home casino when the patron commences patron activity at the non-home casino.

8. A method for tracking loyalty rewards related to a patron based upon patron activity for a patron of a casino enterprise, the casino enterprise comprising a home casino having a home local casino management system and one or more non-home casinos, each having a non-home local casino management system, the method comprising:
storing an offer of a loyalty reward at the home casino local casino management system;
making the offer available at the non-home local casino management system at the non-home casino in which the patron commences patron activity;
if the patron redeems the offer at the non-home casino, sending redemption information to the home local casino management system wherein the offer is removed from the home local casino management system; and
if the patron does not redeem the offer at the non-home casino, removing the offer from the non-home local casino management system.

9. The method of claim 8 further comprising storing the offer of a loyalty reward at an enterprise server.

10. The method of claim 9 wherein the step for making the offer available at the non-home local casino management system comprises requesting and receiving outstanding offers from the enterprise server.

11. The method of claim 8 wherein if the patron redeems the offer at the non-home casino, sending redemption information to the enterprise server wherein the offer is removed from the enterprise server.
